(19) United States
(12) Patent Application Publication
(10) Pub. No.: US 2003/0130690 A1
(43) Pub. Date: Jul. 10, 2003

(54) Non-invasive apparatus and method for treating carpal tunnel syndrome

(76) Inventors: Humberto Luis Porrata, Fort Lauderdale, FL (US); Alejandro Alberto Porrata, Miami, FL (US)

Correspondence Address: Daniel A. Crowe, Bryan Cave LLP, Suite 3600, One Metropolitan Square, St. Louis, MO, 63102, US

(21) Appl. No.: 10/228,395

(22) Filed: Aug. 27, 2002

Related U.S. Application Data
(60) Provisional application No. 60/315,088, filed on Aug. 27, 2001.

(51) Int. Cl. A61H 39/04

(52) U.S. Cl. 606/204; 602/21; 601/134

(57) ABSTRACT

The apparatus of the present invention stretches the carpal ligament and the flexor retinaculum, as well as the superficial structures and muscles of the hand, in a safe manner under precise control of the patient or a healthcare professional. Various embodiments of the inventive apparatus include a housing for receiving the patient's hand with an open top portion and with two internal regions adapted and configured to contact the thenar and hypothenar regions of the patient's palm, while a closeable cover, that fits over the open top region of the housing, includes a pressure element positioned and configured to apply pressure to the dorsal portion of the hand when the cover is depressed and/or closed such that opposing forces of the internal regions pressing on the thenar and hypothenar regions of the palm while the pressure element is pressing on the dorsal portion of the hand cause the carpal ligament and the flexor retinaculum to stretch expanding the carpal tunnel and relieving pressure on the median nerve.

This application claims the benefit of U.S. Provisional Application Serial No. 60/315,088, filed Aug. 27, 2001. This application is related to four concurrently filed co-pending patent applications, namely U.S. Ser. No. ______, entitled Configurable Apparatus and Method for Treating Carpal Tunnel Syndrome, U.S. Ser. No. ______, entitled Adjustable Apparatus and Method for Treating Carpal Tunnel Syndrome, U.S. Ser. No. ______, entitled Adaptable Apparatus and Method for Treating Carpal Tunnel Syndrome, U.S. Ser. No. ______, entitled Automatic Apparatus and Method for Treating Carpal Tunnel Syndrome, as well as co-pending patent application U.S. Ser. No. 10/199,747, entitled Apparatus and Method for Treating Carpal Tunnel Syndrome, filed Jul. 18, 2002, the contents of which are all hereby incorporated herein by reference.

### FIELD OF THE INVENTION

This invention relates generally to treatment of carpal tunnel syndrome, and more particularly to a non-invasive apparatus and method for treatment of carpal tunnel syndrome.

### BACKGROUND OF THE INVENTION

Carpal tunnel syndrome is a physiological disorder that afflicts over 850,000 people each year in the United States alone. In order to better understand the cause of the carpal tunnel syndrome and the difficulty in treating this serious disorder, a detailed explanation of the physiological factors and causes of carpal tunnel syndrome is presented below. Carpal tunnel syndrome is caused by a deleterious increase in pressure on the median nerve which passes through the carpal tunnel (or canal) in the hand, adjacent to the wrist. The deleterious increase in pressure, which is commonly brought on by prolonged repetitive motion of the hand and digits, is often caused by inflammation or damage to tendons for the hand which pass through the carpal tunnel along with the median nerve. Pressure increases can also be caused by narrowing of the carpal canal and by generalized swelling of the structures in the hand. Thus, when the carpal tunnel is narrowed from ligament shortening, muscle development or structural inflammation, the median nerve is undesirably compressed.

The carpal tunnel is formed by the eight carpal bones of the hand adjacent the wrist, which bones are arranged in two rows forming a generally U-shaped inverted arch-like “tunnel” structure. The three large carpal bones of the proximal row (i.e., closest to the chest), beginning laterally (i.e., from the outside with the hand directed downward and the palm facing forward), are the scaphoid, lunate, and triquetrum; the smaller pisiform bone sits on the palmar surface of the triquetrum. The distal row, from lateral to medial, consists of the trapezium, trapezoid, capitate, and hamate carpal bones. The vault of the carpal tunnel is formed by the carpal ligament and the flexor retinaculum. Nine tendons, their tendon sheaths, and the median nerve pass through the tunnel.

The carpal ligament is made of collagen and elastin and extends from the pisiformis and hamulus of hamate bones on the ulnar aspect of the tunnel to the tubercle (i.e., projection) of trapezium and the tubercle of the scaphoid bones on the radial (i.e. lateral) aspect of the carpal tunnel. The flexor retinaculum also stretches across the carpal tunnel and attaches to, on the medial aspect of the carpal tunnel, the pisiform bone and the hook of hamate, and, on the lateral aspect, the tubercle of the scaphoid and trapezium bones. The proximal border of the flexor retinaculum corresponds generally to the transverse skin crease at the base of the hand/wrist. The carpal ligament and flexor retinaculum, along with the carpal bones, form the restricted space through which the median nerve and several tendons pass.

Symptoms of carpal tunnel syndrome include tingling sensation in the hand, discomfort, numbness, and pain localized in the hand or radiating up the arm to the shoulder. All of these symptoms can occur during the day or can make the patients wake up at night. In advanced cases, there is atrophy and weakness of the thenar area of the hand which may weaken the grip and cause objects to fall out of the hand.

Conventional treatment of carpal tunnel syndrome is divided into surgical (invasive) and conservative (non-invasive). Surgical treatment consists of making an incision on the palmar aspect of the hand and splitting the carpal ligament, thus partially opening the carpal tunnel and relieving the pressure. This procedure, while occasionally successful, often has negative consequences, which include, but are not limited to, non-resolution of symptoms often requiring a second surgery, pain in the area of the scar, and injury to the superficial palmar branch of the median nerve causing persistent neurologic symptoms such as loss of full control over the hand. Furthermore, this procedure is very expensive. Understandably, surgical treatment is often considered as a last option.

Conservative, non-invasive treatment is typically separated into three categories—mild, moderate and alternative. Mild treatments may involve the use of anti-inflammatory medications, application of resting hand splints, physical therapy, modification of patient's activities that cause the condition, and even a change in the patient's job. Moderate treatments involve one or more mild treatments coupled with cortisteriod injections. Finally, alternative methods include acupuncture, massage, application of magnets, tai-chi exercises, and the like.

However, none of the above treatments have produced uniformly positive results. While some treatments may alleviate the symptoms of carpal tunnel syndrome in individual patients, the symptoms often return when the course of treatment is terminated. Furthermore, one of the main disadvantages of the various treatment approaches is that they must be delivered by a healthcare provider such as a physician or a physical or occupational therapist. This adds a significant level of inconvenience to the patient who must allocate time to visit the healthcare provider for injections and/or physical therapy. Medications that are used to provide relieve from the pain and discomfort caused by carpal tunnel syndrome also suffer from a number of disadvantages. For example, certain medications have undesirable side effects or interactions with the patient's other medications, if any. As a result, a number of techniques for treating carpal tunnel syndrome that address at least some of the above problems have been developed over the years. Some merely maintain the patient's hand in a neutral position (such as the device disclosed in U.S. Pat. No. 5,014,689) to prevent the symptoms from worsening. Another approach involved mechanical stretching of the carpal ligament, as disclosed in U.S. Pat. No. 5,256,136. Yet another series of techniques advocated placement of a compression bracelet on the forearm (U.S. Pat. No. 5,441,058), or on the wrist (U.S. Pat. No. 5,468,220) to apply a predetermined pressure on certain portions of the forearm, or wrist, respectively, in order to widen the carpal tunnel and thus provide relief to the patient suffering from carpal tunnel syndrome.

However, the above-described previously known devices suffer from a crucial disadvantage. Application of pressure to different portions of the forearm and/or the wrist only has a minimal effect on widening the carpal tunnel, and may only provide temporary relief from carpal tunnel syndrome rather than eliminating or suppressing the condition.

Further development in the area of mechanical treatment of carpal tunnel syndrome continued, and eventually resulted in discovery of the Porrata principle, disclosed in the commonly assigned U.S. Pat. No. 6,146,347 to Humberto Porrata, that provides a novel and advantageous device and method for treating carpal tunnel syndrome that solve the problems posed by previously known devices and techniques. Most importantly, research conducted in conjunction with development of the Porrata device, has shown that carpal tunnel syndrome may be treated with great effectiveness by precise controlled transverse stretching of the carpal ligament and the flexor retinaculum. The 6,146,347 patent disclosed a splint-like device that fit over the patient's hand and a portion of the wrist. The device included rigid sections for contacting the thenar and hypothenar portions of the hand and a selectable active pressure source that, when actuated, applied pressure to the dorsal portion of the patient's hand opposed by the forces delivered by the thenar and hypothenar sections of the device in such a manner, as to transversely stretch the carpal ligament and the flexor retinaculum in a comfortable and controlled manner.

Nevertheless, the device of the 6,146,347 patent is susceptible to improvement. First, because of its construction it generally must be fabricated in different sizes to fit various patients, and patients with unusual hand sized or shapes may need custom-fabricated devices. Second, it generally requires an active adjustable pressure source such as a bladder and pump combination for delivering pressure to the dorsal portion of the hand.

It would thus be desirable to provide an apparatus and method for treating carpal tunnel syndrome by stretching the carpal ligament and the flexor retinaculum of a patient's hand in a comfortable and controlled manner. It would further be desirable to provide an apparatus and method for treating carpal tunnel syndrome embodied in a device that is dynamically adaptable to patients of various physical characteristics. It would also be desirable to provide an apparatus and method for treating carpal tunnel syndrome embodied in a device that is easy and inexpensive to manufacture.

### SUMMARY OF THE INVENTION

The apparatus and method of the present invention advantageously overcome the problems and drawbacks of previously known approaches for treating carpal tunnel syndrome. Similarly to the device disclosed in the commonly assigned U.S. Pat. No. 6,146,347, which is hereby incorporated by reference in its entirety, the main objective of the present invention is to apply the Porrata principle to transversely stretch the carpal ligament and the flexor retinaculum, as well as the superficial structures and muscles of the hand, in a safe manner under precise control of the patient or a healthcare professional. The apparatus and method of the present invention enable the Porrata principle to be implemented in a device that may be readily used by patients with any size or shape hands. Furthermore, the inventive apparatus is very simple and inexpensive to manufacture.

Controlled and monitored use of the inventive apparatus dynamically treats carpal tunnel syndrome through the application of pressure to portions of the palm of the hand (in the thenar and hypothenar areas) while at the same time providing application of pressure, in the opposite direction, to a portion of the dorsum of the hand. This procedure stretches the carpal ligament, the flexor retinaculum, and superficial structures and muscles of the hand in the palmar aspect of the hand, in a readily, safely controllable and comfortable manner.

Considering that the constitutions of the carpal ligament and the flexor retinaculum are soft tissue composed of collagen and elastin, stretching the carpal ligament and the flexor retinaculum is effective for decreasing compression on the median nerve by increasing the diameter of the tunnel and decreasing the rigidity of the retinaculum and the carpal ligament, thus alleviating the symptoms of carpal tunnel syndrome.

Various embodiments of the inventive apparatus commonly include a housing for receiving the patient's hand with an open top portion and with two internal regions adapted and configured to contact the thenar and hypothenar regions of the patient's palm, while a closeable cover that fits over the open top region of the housing includes a pressure element positioned and configured to apply pressure to the dorsal portion of the hand when the cover is depressed and/or closed.

Accordingly, the inventive apparatus is inexpensive and readily usable by any patient to prevent progression of carpal tunnel syndrome and to provide relief from symptoms by increasing the cross sectional area of the carpal tunnel, thus decreasing compression on the median nerve and decreasing the resulting symptoms.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein like reference characters denote like elements throughout the several views:

FIG. 1 is a cross section view of a first embodiment of the inventive apparatus for treating carpal tunnel syndrome;

FIG. 2 is an isometric top view of the first embodiment of the inventive apparatus for treating carpal tunnel syndrome of FIG. 1;

FIG. 3 is a cross section view of the first embodiment of the inventive apparatus for treating carpal tunnel syndrome of FIG. 1 during utilization.

FIG. 4 is a cross section view of a second embodiment of the inventive apparatus for treating carpal tunnel syndrome;

FIG. 5 is a cross section view of a third embodiment of the inventive apparatus for treating carpal tunnel syndrome;

FIG. 6 is a cross section view of a fourth embodiment of the inventive apparatus for treating carpal tunnel syndrome;

FIG. 7 is a cross section view of a fifth embodiment of the inventive apparatus for treating carpal tunnel syndrome;

FIG. 8 is a cross section view of a sixth embodiment of the inventive apparatus for treating carpal tunnel syndrome; and

FIG. 9 is an isometric top view of the sixth embodiment of the inventive apparatus for treating carpal tunnel syndrome of FIG. 6.

### DETAILED DESCRIPTION OF PREFERRED EMBODIMENTS

The present invention is described with reference to various materials that compose the inventive structures and elements thereof, and to various devices for selectively applying pressure to a specific area of the hand, by way of example only—it should be understood that the apparatus and method of the present invention may be utilized with any materials or selective pressure sources having properties similar to those described in the exemplary embodiments, without departing from the spirit of the invention.

The essence of the Porrata approach, disclosed and described in greater detail in the above-incorporated U.S. Pat. No. 6,146,347, involves applying pressure to a portion of the top surface of the hand (i.e., the central dorsal region), while at the same time applying opposing pressure to the thenar and hypothenar regions of the palm. The apparatus and method of the present invention advantageously implement the Porrata principle in a simple to use device that works equally well with different hand shapes and sizes.

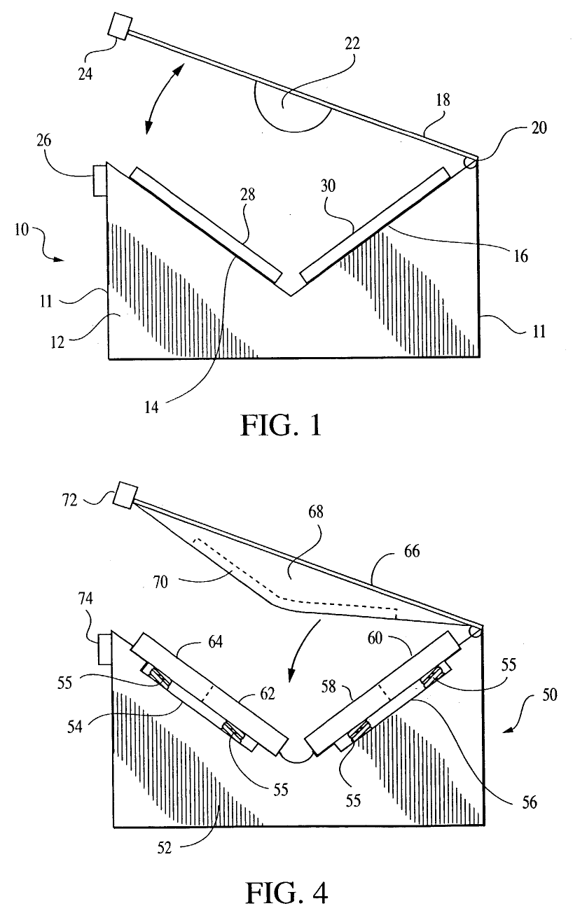

Referring now to FIG. 1, a first embodiment of an inventive apparatus 10 is shown. The apparatus 10 includes a housing 12 with a first support element 14 for supporting the thenar region of the hand, and a second support element 16 for supporting the hypothenar region of the hand. The housing 12 has side walls 11 and may be composed of a rigid material such as metal, hard plastic or wood, or a resilient material such as fiberglass or resilient plastic, or a combination thereof. The support elements 14, 16 may be rigid portions of the housing 12 composed of the same material or, alternately, may incorporate respective resilient comfort elements 28, 30 to improve contact with the respective thenar and hypothenar regions of the hand and to improve patient comfort. The support elements 14, 16 are substantially parallel to each other generally along the longitudinal axis of the patient's hand. The comfort elements 28, 30 may be composed of any resilient material, including but not limited to: soft plastic, silicone gel, padding, foam, spring elements, and a fluid or air-filled bladder. Optionally, the comfort elements 28, 30 may incorporate active pressure sources such as inflatable bladders or electromagnetic plates. The support elements 14 and 16 may be adjustable in position and orientation to better correspond to the size and shape of the patient's hand. Alternatively, the support elements 14 and 16 may incorporate active pressure sources such as inflatable bladders or electromagnetic plates.

A cover 18 is pivotably attached to the housing 12 by a hinge element 20, which may be a hinge or a piece of a flexible material. The cover 18 includes an elongated pressure element 22 disposed along its length and configured to contact a substantially central dorsal region of the hand along its longitudinal axis when the cover 18 is closed. Preferably, the pressure element 22 is sized to cover a sufficiently large portion of the surface of the dorsal portion of the hand, particularly in the transverse direction, to reduce the pressure applied to any particular nerve or artery in the hand. The pressure element 22 may be composed of a rigid material, such as metal, wood, plastic or fiberglass, or it may be composed of a resilient material such as soft plastic, silicone gel, padding, foam, and a fluid or air-filled bladder, or a combination of one or more resilient and rigid materials.

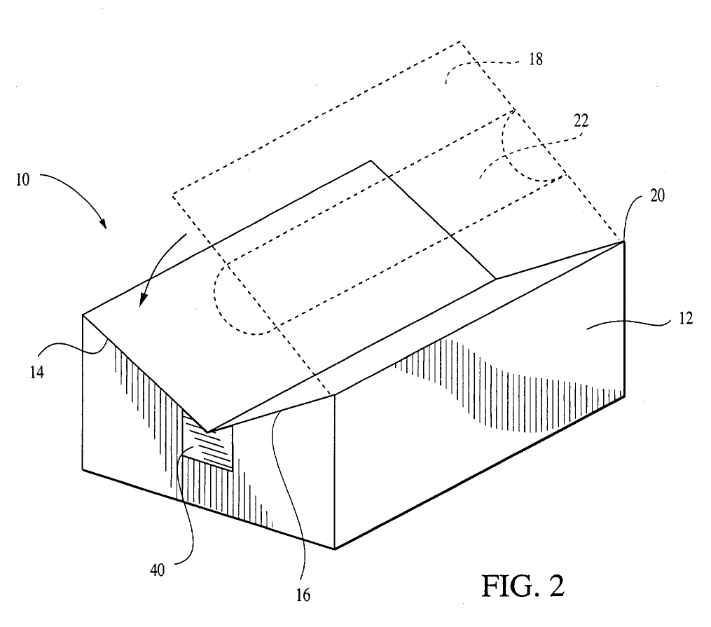

Referring now to FIG. 2, a different view of the apparatus 10 is shown. FIG. 2 also shows that the apparatus 10 may also include an electronic device 40 that includes a laser or similar device adapted to specifically denature the proteins that make up the ligaments in the body, thus making it easier to stretch the ligaments. The electronic device 40 is preferably aligned with the flexor retinaculum or carpal ligament as the hand is placed in the apparatus 10. The electronic device 40 may also include conventional sensors to measure the amount of stretching or elongation of the flexor retinaculum or carpal ligament through, e.g., tension measurements or displacement of carpal bones.

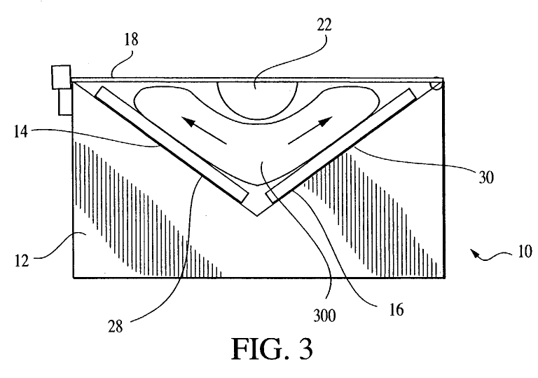

Referring now to FIG. 3, the operation of the apparatus 10 is shown. A patient places a hand 300 into the housing such that the thenar region of the palm is positioned over the support element 14 and the hypothenar region of the palm is positioned over the support element 16 (or over optional comfort elements 28, 30). The wrist of the hand 300 is received through an open side portion of the housing 12. The cover 18 is closed over the open top portion of the housing 12 such that the pressure element 22 contacts and presses down on the central dorsal region of the hand 300 along its longitudinal axis, which pressure is balanced and opposed by a second force formed by retaining action of the support elements 14, 16 exerted on the respective thenar and hypothenar regions of the hand. These opposing forces cause carpal bones of the hand to separate to stretch a carpal ligament and a flexor retinaculum of the hand, thus implementing the Porrata principle to widen the carpal canal and provide treatment of carpal tunnel syndrome to the patient.

Referring back to FIG. 1, an optional releasable locking device 24, 26 may be positioned on the cover 18 and housing 12, respectively to maintain the cover 18 in a locked position when it is closed over the hand. The locking device 24, 26 may be a clasp, a hook and loop combination (i.e. Velcro), a latch or any other releasable retaining device.

Referring now to FIG. 4, a second embodiment of the inventive apparatus is shown as an apparatus 50. The apparatus 50 includes a housing 52 with a side 54, having a first set of independent support elements 62, 64 for supporting the thenar region of the hand, and a second side 56 having a second set of independent support elements 58, 60 for supporting the hypothenar region of the hand. The housing 52 may be composed of a rigid material such as metal, hard plastic or wood, or a resilient material such as fiberglass or resilient plastic, or a combination thereof. The independent support elements 58, 60, 62, 64 may be composed of a resilient material, including, but not limited to: soft plastic, silicone gel, padding, foam, and a fluid or air-filled bladder. Alternatively, they may be composed of a rigid material having a resilient lining, or spring elements 55 in contact with sides 54 and 56. Multiple independent support elements 58, 60, 62, 64 are advantageous because they enable the apparatus 50 to adjust to the shape of the patient's hand. While only two independent support elements are shown on each side 54, 56, a greater number of independent support elements may be implemented without departing from the spirit of the present invention.

A cover 66 is pivotably attached to the housing 52 by a hinge element which may be a hinge or a piece of a flexible material. The cover 66 includes an elongated pressure element 68 disposed along its length and configured to contact a substantially central dorsal region of the hand along its longitudinal axis when the cover 66 is closed. The pressure region 68 may be composed of the same material as the cover 66, such as metal, wood, plastic or fiberglass, or it may incorporate a resilient contact pad 70 composed of a resilient material such as soft plastic, silicone gel, padding, foam, and a fluid or air-filled bladder. An optional releasable locking device 72, 74 may be positioned on the cover 66 and housing 52, respectively to maintain the cover 66 in a locked position when it is closed over the hand. The locking device 72, 74 may be a clasp, a hook and loop combination (i.e. Velcro), a latch, or any other releasable retaining device.

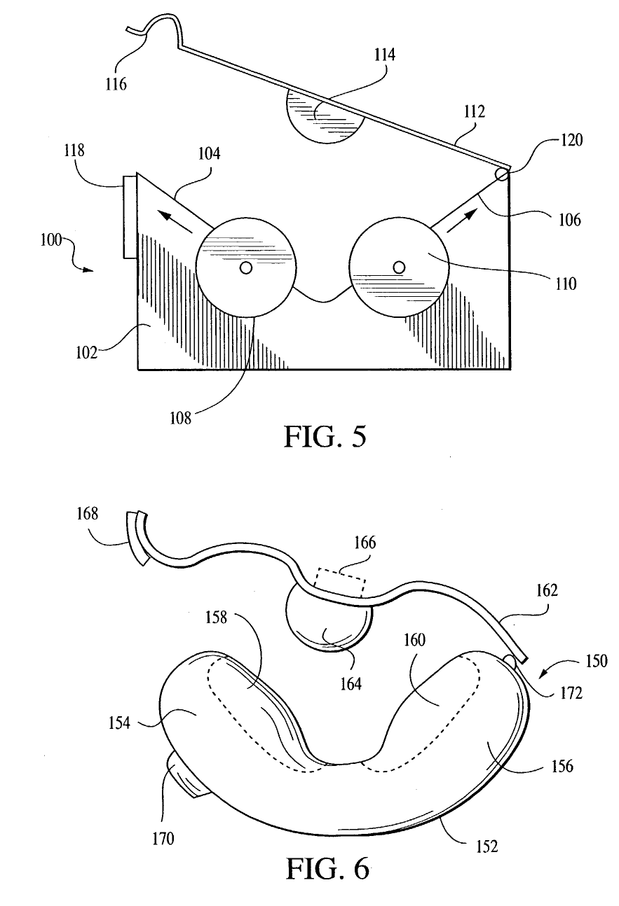

Referring now to FIG. 5, a third embodiment of the inventive apparatus is shown as an apparatus 100. The apparatus 100 is similar in construction and operation to the apparatus 10 of FIG. 1, except that a first mobile cylindrical roller 108 is positioned along a thenar support region 104, and a second mobile cylindrical roller 110 is positioned along a hypothenar support region 106. The cylindrical rollers are configured such that when a patient places their palm on the rollers 106, 108 and a cover 112 is closed, the pressure exerted by a pressure element 114 on the dorsal part of the hand causes the rollers 106, 108 to move away from a central portion of the palm along the respective sides 104, 106 to contact and support the respective thenar and hypothenar regions of the palm. Thus, this embodiment provides a dynamically adjustable support to the thenar and the hypothenar regions of the hand irrespective of the hand's size.

Referring now to FIG. 6, a fourth embodiment of the inventive apparatus is shown as apparatus 150. The apparatus 150 is similar in operation to the apparatus 10 of FIG. 1 (for example, sides 156 and 156 correspond to support elements 14 and 16, and comfort elements 158 and 160 correspond to comfort elements 28 and 30), except that a cover 162 is composed of a flexible material or a resilient stretchable material. A pressure element 164 may be configured to move along the cover 162 via an adjustment device 166. For example, the pressure element 164 (which may be similar to the pressure elements of the various other embodiments described herein) may include a knob seated within a slot in cover 162 by which the user may slide the pressure element 164 within the slot. This arrangement is advantageous because stretching tension can be applied to the cover 162 to thereby exert greater pressure on the dorsal region of the hand via the pressure element 164. This adjustment device 166 may be incorporated into any of the other embodiments described herein. The adjustment device 166 may include or be coupled with a pressure measuring gauge allowing the user to increase the pressure on the dorsal portion of the hand to a pre-determined level. A releasable retaining device 168, 170 is configured to releasably retain the cover 162 when it is closed and is optionally configurable to maintain different levels of tension in the cover 162 when the cover 162 is stretchable.

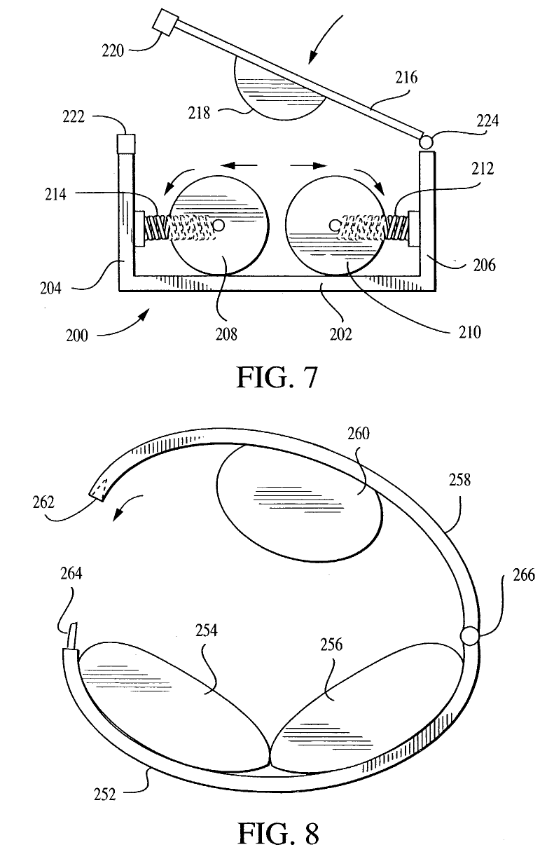

Referring now to FIG. 7, a fifth embodiment of the apparatus of present invention is shown as an apparatus 200. The apparatus 200 is similar in operation to the apparatus 100 of FIG. 3 except that rollers 208, 210 in contact with spring elements 212, 214 move along a bottom of a housing 202, rather than at an angle as in apparatus 100 of FIG. 3. Apparatus 200 includes sides 204, 206, cover 216 with attached pressure element 218, hinge 224, and optional releasable locking device 220, 222.

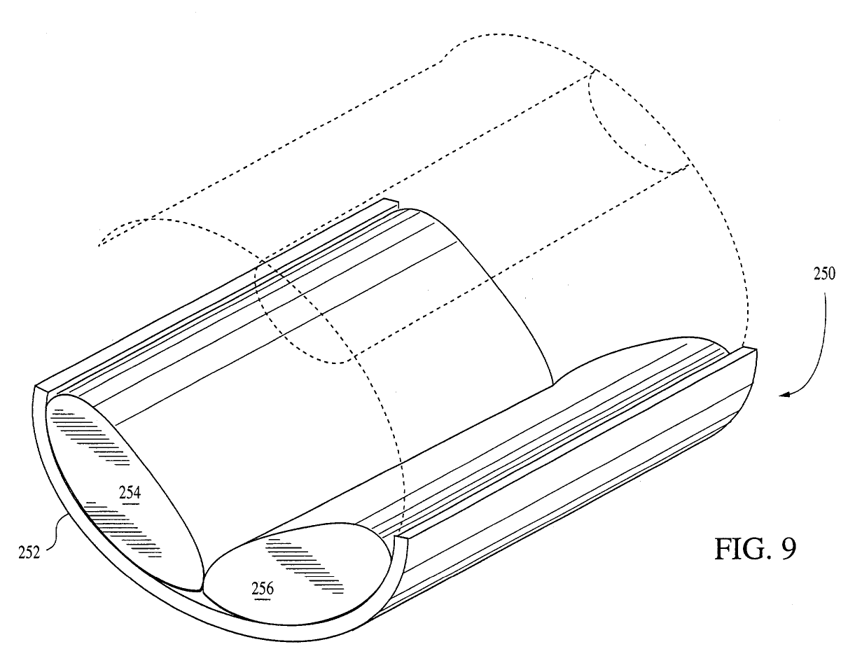

Referring now to FIG. 8, a sixth embodiment of the inventive apparatus is shown as an apparatus 250. The apparatus 250 includes a housing 252 having a generally semi-circular cross-section, with a first support element 254 for supporting the thenar region of the hand disposed along one side of an internal concave region of the housing, and a second support element 256 for supporting the hypothenar region of the hand disposed along the other side of the concave region of the housing. The housing 252 may be composed of a rigid material such as metal, hard plastic or wood, or a resilient material such as fiberglass or resilient plastic, or a combination thereof. The support elements 254, 256 may be composed of any resilient material, including but not limited to: soft plastic, silicone gel, padding, foam, spring elements, and a fluid or air-filled bladder. Optionally, the support elements 254, 256 may incorporate active pressure sources, such as inflatable bladders or electromagnetic plates. The support elements 254, 256 may be adjustable in position and orientation to better correspond to the size and shape of the patient's hand. Alternatively, the support elements 254, 256 may be composed of a substantially rigid material such as metal, plastic, wood or fiberglass.

A cover 258 is pivotably attached to the housing 252 by a hinge element 266, which may be a hinge or a piece of a flexible material. The cover 258 includes an elongated pressure element 260 disposed along its length and configured to contact a substantially central dorsal region of the hand along its longitudinal axis when the cover 258 is closed. The pressure element 260 may be composed of a rigid material, such as metal, wood, plastic or fiberglass, or it may be composed of a resilient material such as soft plastic, silicone gel, padding, foam, and a fluid or air-filled bladder, or a combination of one or more resilient and rigid materials. Referring now to FIG. 9, a different view of the apparatus 250 is shown.

Referring back to FIG. 8, an optional releasable locking device 262, 264 may be positioned on the cover 258 and housing 252, respectively to maintain the cover 258 in a locked position when it is closed over the hand. The locking device 262, 264 may be a clasp, a hook and loop combination (i.e. Velcro), a latch, or any other releasable retaining device.

It should be noted that the individual elements shown in the various embodiments may be readily utilized in different embodiments or mixed without departing from the spirit of the invention. For example, the flexible cover 162 of the apparatus 150 of FIG. 6 may replace the rigid cover of the apparatus 10 of FIG. 1. In addition, the electronic device 40 illustrated in FIG. 2 may be incorporated into the various other embodiments. Furthermore, while cross sections of the various embodiments of the inventive apparatus are shown to be of rectangular or elliptical in shape, the cross section of the inventive apparatus may comprise any other geometrical shape without departing from the spirit of the invention.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. An apparatus for treating carpal tunnel syndrome in a person's hand, the hand having a longitudinal axis, a palmar aspect with thenar and hypothenar regions, and a dorsal region opposed to the palmar aspect, the apparatus comprising:
a housing having a first side wall, a second side wall, an open top portion for receiving the hand, and a first open side portion, substantially perpendicular to said first and second side walls, for receiving the wrist;
first support means, disposed within said housing along the longitudinal axis of the hand, for contacting and retaining the thenar region of the hand;
second support means, disposed within said housing substantially parallel to said first support means, for contacting and retaining the hypothenar region of the hand;
a cover having a bottom portion, a first edge and a second opposing edge, said first edge being pivotably attached to a top portion of said first side wall, said cover being operable to close over said open top portion into a closed position; and
an elongated pressure element disposed on said bottom portion of said cover along the longitudinal axis and positioned and configured to contact and exert pressure along the dorsal region of the hand when said cover is pushed downward toward said open top portion, such that a first force formed by said pressure is balanced and opposed by a second force formed by retaining action of said first and said second support means exerted on the respective thenar and hypothenar regions of the hand, wherein said first and said second forces cause carpal bones of the hand to separate to stretch a carpal ligament and a flexor retinaculum of the hand.

2. The apparatus of claim 1, further comprising a first resilient pad disposed along said first support means, and a second resilient pad disposed along said second support means.

3. The apparatus of claim 1, wherein said first support means comprises a first plurality of independent resilient support elements, and wherein said second support means comprises a second plurality of independent resilient support elements.

4. The apparatus of claim 1, wherein said first support means comprises a first mobile generally cylindrical elongated element positioned and configured to initially contact a first region of the hand between the thenar region and a central portion of the palmar aspect of the hand, wherein said second support means comprises a second mobile generally cylindrical elongated element positioned and configured to initially contact a second region of the hand between the hypothenar region and the central portion of the palmar aspect of the hand, wherein when said cover is moved towards said closed position and said elongated member exerts pressure on the dorsal region of the hand, said first mobile element moves from said first region to the thenar region of the hand, and said second mobile element moves from said second region to the hypothenar region of the hand, such that dynamically adjustable support to the thenar and the hypothenar regions of the hand irrespective of the hand's size is thereby provided.

5. The apparatus of claim 1, wherein said first and said second support means comprise said first and said second side walls, respectively.

6. The apparatus of claim 1, wherein said cover is composed of at least one of: a rigid material and a flexible material.

7. The apparatus of claim 1, further comprising a releasable retaining means positioned on said second edge of said cover and on an outer portion of said second side wall for maintaining said cover in said closed position during treatment and for releasing said cover into an open position after treatment.

8. The apparatus of claim 1, further comprising adjustment means for selectively moving said elongated pressure element substantially between said first and said second edges of said cover.

9. The apparatus of claim 8, wherein the adjustment means further comprises means for measuring the amount of pressure exerted by the elongated pressure element on the dorsal region of the hand.

10. The apparatus of claim 1, wherein the housing has a generally semi-circular cross-section having an internal concave region, the first support means is disposed along one side of the internal concave region of the housing, and the second support means is disposed along the other side of the concave region of the housing.

11. The apparatus of claim 1 further comprising an electronic device comprising a laser adapted to denature proteins forming the flexor retinaculum and the carpal ligament.

12. The apparatus of claim 11 wherein the electronic device further comprises a sensor to measure the amount that the flexor retinaculum stretches.

13. An apparatus for treating carpal tunnel syndrome in a person's hand, the hand having a longitudinal axis, a palmar aspect with thenar and hypothenar regions, and a dorsal region opposed to the palmar aspect, the apparatus comprising:
a housing having a first side wall, a second side wall, an open top portion for receiving the hand, and a first open side portion, substantially perpendicular to said first and second side walls, for receiving the wrist;
a first support element disposed within said housing along the longitudinal axis of the hand, for contacting and retaining the thenar region of the hand;
a second support element disposed within said housing substantially parallel to said first support element for contacting and retaining the hypothenar region of the hand;
a cover having a bottom portion, a first edge and a second opposing edge, said first edge being pivotably attached to a top portion of said first side wall, said cover being operable to close over said open top portion into a closed position; and
an elongated pressure element disposed on said bottom portion of said cover along the longitudinal axis and positioned and configured to contact and exert pressure along the dorsal region of the hand when said cover is pushed downward toward said open top portion, such that a first force formed by said pressure is balanced and opposed by a second force formed by retaining action of said first and said second support elements exerted on the respective thenar and hypothenar regions of the hand, wherein said first and said second forces cause carpal bones of the hand to separate to stretch a carpal ligament and a flexor retinaculum of the hand.

14. The apparatus of claim 13, further comprising a first resilient pad disposed along said first support element, and a second resilient pad disposed along said second support element.

15. The apparatus of claim 13, wherein said first support element comprises a first plurality of independent resilient support elements, and wherein said second support element comprises a second plurality of independent resilient support elements.

16. The apparatus of claim 13, wherein said first support element comprises a first mobile generally cylindrical elongated element positioned and configured to initially contact a first region of the hand between the thenar region and a central portion of the palmar aspect of the hand, wherein said second support element comprises a second mobile generally cylindrical elongated element positioned and configured to initially contact a second region of the hand between the hypothenar region and the central portion of the palmar aspect of the hand, wherein when said cover is moved towards said closed position and said elongated member exerts pressure on the dorsal region of the hand, said first mobile element moves from said first region to the thenar region of the hand, and said second mobile element moves from said second region to the hypothenar region of the hand, such that dynamically adjustable support to the thenar and the hypothenar regions of the hand irrespective of the hand's size is thereby provided.

17. The apparatus of claim 13, wherein said first and said second support element comprise said first and said second side walls, respectively.

18. The apparatus of claim 13, wherein said cover is composed of at least one of: a rigid material and a flexible material.

19. The apparatus of claim 13, further comprising a releasable retaining means positioned on said second edge of said cover and on an outer portion of said second side wall for maintaining said cover in said closed position during treatment and for releasing said cover into an open position after treatment.

20. The apparatus of claim 13, further comprising adjustment means for selectively moving said elongated pressure element substantially between said first and said second edges of said cover.

21. The apparatus of claim 20, wherein the adjustment means further comprises means for measuring the amount of pressure exerted by the elongated pressure element on the dorsal region of the hand.

22. The apparatus of claim 13, wherein the housing has a generally semi-circular cross-section having an internal concave region, the first support means is disposed along one side of the internal concave region of the housing, and the second support means is disposed along the other side of the concave region of the housing.

23. The apparatus of claim 13 further comprising an electronic device comprising a laser adapted to denature proteins forming the flexor retinaculum and the carpal ligament.

24. The apparatus of claim 13 wherein the electronic device further comprises a sensor to measure the amount that the flexor retinaculum stretches.
